(19) United States
(12) Patent Application Publication
(10) Pub. No.: US 2010/0111418 A1
(43) Pub. Date: May 6, 2010

(54) IMAGE QUALITY IMPROVEMENT PROCESSING METHOD AND IMAGE QUALITY IMPROVEMENT PROCESSING PROGRAM WHICH SUPPORT PLURAL REGIONS

(75) Inventors: Masatoshi Okutomi, Tokyo (JP); Masayuki Tanaka, Tokyo (JP)

Correspondence Address: NIXON PEABODY, LLP, 401 9TH STREET, NW, SUITE 900, WASHINGTON, DC, 20004-2128, US

(73) Assignee: TOKYO INSTITUTE OF TECHNOLOGY, Meguro-Ku, Tokyo (JP)

(21) Appl. No.: 12/532,008

(22) PCT Filed: Mar. 4, 2008
(86) PCT No.: PCT/JP2008/054237

§ 371 Date: Sep. 18, 2009

(30) Foreign Application Priority Data
Mar. 19, 2007 (JP) 2007-070401

(51) Int. Cl. G06K 9/34; G06K 9/40

(52) U.S. Cl. 382/173; 382/254

(57) ABSTRACT

The present invention provides an image quality improvement processing method corresponding to multiple regions that performs the image quality improvement processing so as to be capable of simultaneously displaying multiple regions of interest that image quality is improved and the entire basis image without generating unnatural edges in boundaries between regions of interest even in the case that multiple regions of interest are set in the basis image.

An image quality improvement processing method corresponding to multiple regions that generates an image-quality-improved image from multiple observed images having displacements, comprises a step that extracts multiple regions of interest with respect to a basis image selected from the multiple observed images; a step that performs the registration processing for every region of interest with respect to extracted multiple regions of interest; and a step that performs the image quality improvement processing by simultaneously using the pixel value data of multiple regions of interest that the registration processing is performed and the pixel value data of the basis image and generates the image-quality-improved image.

### TECHNICAL FIELD

The present invention relates to digital image processing technologies, more particularly, to an image quality improvement processing method and an image quality improvement processing computer program that correspond to multiple regions.

### BACKGROUND TECHNIQUE

In image processing technologies, there is the image quality improvement processing that generates an image with high image quality by using multiple input images (multiple observed images). “The super-resolution processing” is one of such an image quality improvement processing.

The super-resolution processing is a processing that estimates (reconstructs) one high-resolution image by using multiple low-resolution images (multiple observed images) having displacements, more specifically, consists of “a registration processing” that registers multiple observed images having displacements and “a high-resolution-ization processing” that generates (estimates) a high-resolution image based on pixels of multiple observed images after registration.

### DISCLOSURE OF THE INVENTION

The present invention relates to an image quality improvement processing method corresponding to multiple regions that generates an image-quality-improved image from multiple observed images having displacements, an aspect of the present invention is an image quality improvement processing method characterized by comprising: a region of interest extraction processing step that extracts multiple regions of interest with respect to a basis image selected from said multiple observed images; a registration processing step that performs the registration processing for every region of interest with respect to extracted multiple regions of interest; and a simultaneous image quality improvement processing step that performs the image quality improvement processing by simultaneously using the pixel value data of multiple regions of interest that the registration processing is performed and the pixel value data of said basis image and generates said image-quality-improved image, and a computer program that make a computer to carry out said image quality improvement processing method.

### BRIEF DESCRIPTION OF THE DRAWINGS

FIG. 1 is a conceptual diagram illustrating the pixel value data used in “the high-resolution-ization processing” according to the conventional super-resolution processing;

FIG. 2 is a conceptual diagram illustrating the pixel value data used in “the simultaneous image quality improvement processing” of the present invention;

FIG. 3 is a conceptual diagram illustrating a flow of the image processing based on the conventional “super-resolution processing” in the case of setting multiple regions of interest in the basis image;

FIG. 4 is a conceptual diagram illustrating a flow of the image processing based on the present invention in the case of setting multiple regions of interest in the basis image;

FIG. 5 shows a basis image that three regions of interest are set;

FIG. 6 shows high-resolution-ization processing results that are obtained based on the conventional “super-resolution processing” with respect to three regions of interest in the basis image shown in FIG. 5;

FIG. 7 shows an image-quality-improved image that is obtained by using the basis image and three regions of interest shown in FIG. 5 and applying the present invention; and

FIG. 8 is a block diagram illustrating an undefined pixel value estimating method that utilizes alpha blending in Embodiment 2 of the present invention.

### THE BEST MODE FOR CARRYING OUT THE INVENTION

The following is a description of preferred embodiments for carrying out the present invention, with reference to the accompanying drawings.

“An image quality improvement processing method and an image quality improvement processing computer program that correspond to multiple regions” according to the present invention, are the digital image processing technologies that perform the image quality improvement processing so as to be capable of simultaneously displaying multiple regions of interest that image quality is improved and the entire basis image without generating unnatural edges in boundaries between regions of interest even in the case that multiple regions of interest are set in the basis image.

The present invention is mainly characterized by setting multiple regions of interest in the same basis image, simultaneously considering multiple regions of interest that “the displacement processing” is performed and at least one region that is not set as the region of interest (i.e. region (s) other than regions of interest in the basis image), and performing the image quality improvement processing.

In general, it is possible to regard “the high-resolution-ization processing” in the conventional super-resolution processing as the image reconstruction from the pixel value data sampled at unequal interval within “a high-resolution image space” (hereinafter also simply referred to as “the data”) in principle. As a result, in principle, it is possible to compute “the high-resolution-ization processing” even by using only one basis image.

However, in the case of performing “the high-resolution-ization processing” by using only one basis image, since the data quantity usable for “the high-resolution-ization processing” is essentially insufficient, it is impossible to effectively improve the resolution.

On the other hand, by performing the registration processing between multiple images and using the multiple images based on the registration information obtained by the registration processing, it is possible to perform the high-resolution-ization processing capable of effectively improving the resolution. That is to say, with respect to the region of interest that “the registration processing” is performed, it is possible to obtain the high-resolution-ization based on “the high-resolution-ization processing”.

In conventional “super-resolution processing”, the pixel value data other than regions of interest in the basis image, i.e., the pixel value data of region(s) other than regions of interest is not used in “the high-resolution-ization processing”.

Hence, in the case that multiple regions of interest exist in the basis image, the pixel value data used in “the high-resolution-ization processing” of the conventional “super-resolution processing” is only the pixel value data of these regions of interest that “the registration processing” is performed, that is to say, in region (s) other than these regions of interest, there is not the pixel value data used in “the high-resolution-ization processing” at all.

Here, FIG. 1 shows a conceptual diagram illustrating the pixel value data used in “the high-resolution-ization processing” of the conventional “super-resolution processing”. In addition, in FIG. 1, pixels that there is the pixel value data used in “the high-resolution-ization processing” are represented by white, and pixels that there is no the pixel value data used in “the high-resolution-ization processing” are represented by black.

As shown in FIG. 1, the conventional super-resolution processing selects a basis image from multiple low-resolution images (multiple observed images) that become the input image of the super-resolution processing, and sets regions that want to be high-resolution-ized as regions of interest. In the case of FIG. 1, region of interest 1 and region of interest 2 are set.

In conventional “super-resolution processing”, even to simultaneously consider multiple regions of interest, in the end, it becomes the same as considering each region of interest separately. As also shown in the conceptual diagram of FIG. 1, in the conventional “super-resolution processing”, after “the registration processing” is performed for every region of interest, the actual computation of “the high-resolution-ization processing” is separately computed for every region of interest, that is to say, “the high-resolution-ization processing” is performed for every region of interest.

On the other hand, in the present invention, as described above, since the image quality improvement processing is simultaneously performed for multiple regions of interest that “the displacement processing” is performed and at least one region that is not set as the region of interest (i.e. region (s) other than these regions of interest in the basis image), that is to say, since “the simultaneous image quality improvement processing” is performed, by one time of “the simultaneous image quality improvement processing”, it is possible to generate a result image that is capable of simultaneously displaying multiple regions of interest that image quality is improved and the entire basis image.

In short, in the case that multiple regions of interest exist in the basis image, as the pixel value data used in “the simultaneous image quality improvement processing” of the present invention, not only the pixel value data of these regions of interest that “the registration processing” is performed but also the pixel value data of the entire basis image are used, when saying more closely, the pixel value data of region (s) other than these regions of interest is also used as the pixel value data used in “the simultaneous image quality improvement processing” of the present invention.

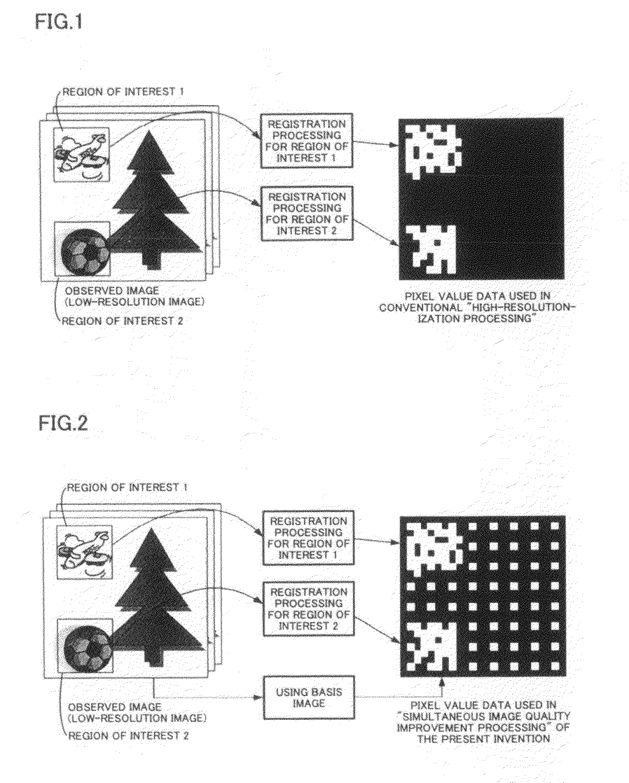

Here, FIG. 2 shows a conceptual diagram illustrating the pixel value data used in “the simultaneous image quality improvement processing” of the present invention. In addition, in FIG. 2, pixels that there is the pixel value data used in “the simultaneous image quality improvement processing” are represented by white, and pixels that there is no the pixel value data used in “the simultaneous image quality improvement processing” are represented by black.

As shown in FIG. 2, the image processing based on the present invention selects a basis image from multiple low-resolution images (multiple observed images) that become its input image of the super-resolution processing, and sets regions that image quality wants to improved as regions of interest. In the case of FIG. 2, region of interest 1 and region of interest 2 are set. With respect to region of interest 1 and region of interest 2, after “the registration processing” is performed respectively, not only the pixel value data of regions that the registration processing is already performed but also the pixel value data of the basis image are simultaneously used in “the simultaneous image quality improvement processing” of the present invention.

That is to say, in the present invention, since the pixel value data used in “the simultaneous image quality improvement processing” exist in the range of the entire basis image, it is possible to obtain an image with the range of the entire basis image by performing “the simultaneous image quality improvement processing” based on this pixel value data.

In this case, as also shown in the conceptual diagram of FIG. 2, since the pixel value data densely exists in each region of interest, the image quality improvement with respect to each region of interest becomes possible, and since the pixel value data sparsely exists in region(s) other than regions of interest, although the image quality of region(s) other than regions of interest is not improved (varied), due to perform the same processing with respect to the range of the entire image, boundaries with unnatural edges do not occur in the image-quality-improved image generated by the present invention. That is to say, in the result image based on the present invention, unnatural edges do not exist in boundaries between the region (s) that the image quality does not vary and each region of interest that the image quality is improved.

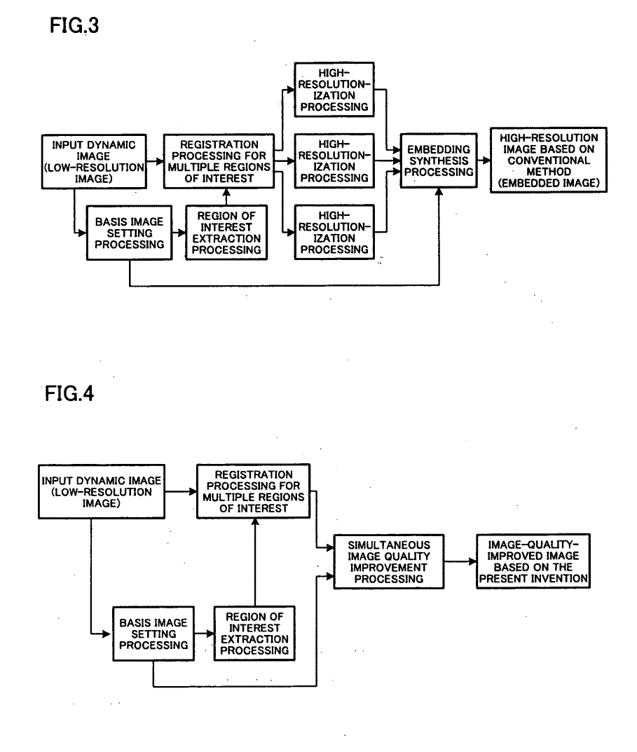

FIG. 3 shows a flow of the image processing based on the conventional “super-resolution processing” in the case of setting multiple regions of interest in the basis image.

As shown in FIG. 3, in the image processing based on the conventional “super-resolution processing”, firstly, “a basis image setting processing” that selects (sets) a basis image from multiple observed images having displacements which become its input images (the case of FIG. 3 is an input dynamic image) is performed, “a region of interest extraction processing” that extracts (sets) multiple regions of interest with respect to the selected basis image is performed, and then based on the extracted multiple regions of interest and the input dynamic image, “a registration processing” is performed for every region of interest.

Next, with respect to each region of interest that the registration processing is already performed, “a high-resolution-ization processing” is performed separately. And then, in order to generate a high-resolution image that simultaneously displays all high-resolution-ized regions of interest by “the high-resolution-ization processing” and the basis image, “an embedding synthesis processing” that embeds each high-resolution-ized region of interest in the basis image is performed. That is to say, by such “an embedding synthesis processing”, a result image of the image processing based on the conventional super-resolution processing (a high-resolution image based on the conventional method, i.e. an embedded image), is generated.

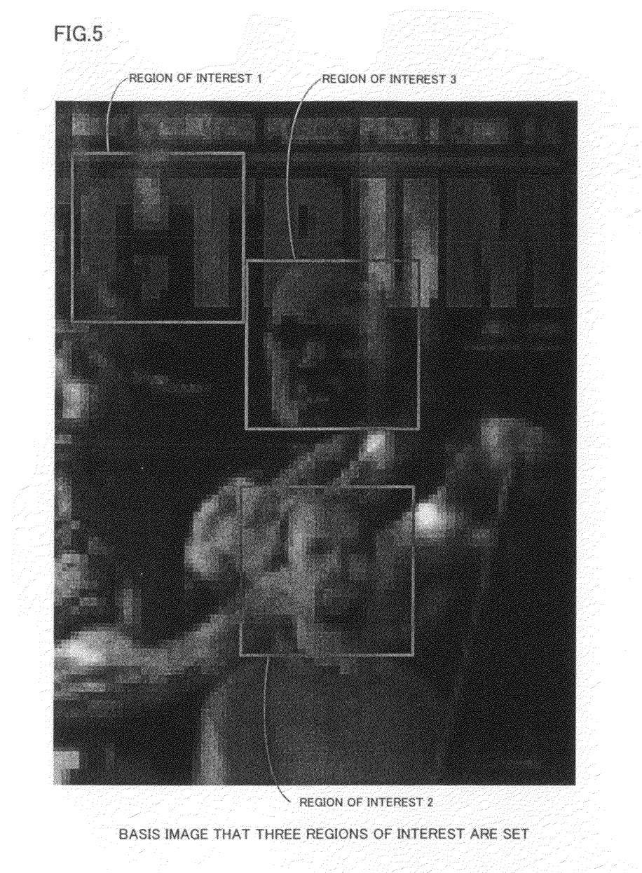

Further, FIG. 4 shows a flow of the image processing based on the present invention in the case of setting multiple regions of interest in the basis image.

As shown in FIG. 4, in the image processing based on the present invention, firstly, “a basis image setting processing” that selects (sets) a basis image from multiple observed images having displacements which become its input images (the case of FIG. 4 is an input dynamic image) is performed, “a region of interest extraction processing” that extracts (sets) multiple regions of interest with respect to the selected basis image is performed, and then based on the extracted multiple regions of interest and the input dynamic image, “a registration processing” is performed for every region of interest.

And then, by performing “a simultaneous image quality improvement processing” that is the most remarkable technical characteristic of the present invention, a result image of the image processing based on the present invention is generated. That is to say, “the simultaneous image quality improvement processing” of the present invention, generates a result image having a feature that is capable of simultaneously displaying all regions of interest that image quality is improved and the entire basis image, by simultaneously performing the image quality improvement processing based on all regions of interest that the registration processing is already performed and the basis image.

In other words, in the present invention, by performing “the simultaneous image quality improvement processing” just one time, it is possible to generate a result image that is capable of simultaneously displaying all regions of interest that image quality is improved and the entire basis image.

In “the region of interest extraction processing” of the present invention, as methods that extract multiple regions of interest, for example, it is possible to use methods such as [1] a method that sets multiple regions appointed by a user with respect to the basis image as multiple regions of interest, [2] a method that sets multiple regions obtained by simply dividing the basis image into a predetermined size as multiple regions of interest, [3] a method that sequentially extracts the superiority region with respect to the basis image and sets extracted multiple superiority regions as multiple regions of interest, and [4] a method that extracts multiple regions of interest by using object detection (for example, face detection) with respect to the basis image.

Further, in “the registration processing” of the present invention, the existing method is used. For example, it is possible to use methods such as “a motion estimating method for an image sequence” disclosed in Patent Document 1 proposed by Okutomi, et al. and a method disclosed in Non-Patent Document 1.

Moreover, in “the simultaneous image quality improvement processing” of the present invention, when performing the image quality improvement processing by simultaneously using the pixel value data of multiple regions of interest that the registration processing is performed and the pixel value data of the basis image, that is to say, here, in the case of using the high-resolution-ization processing as the image quality improvement processing, it is more effective by using “a fast method of super-resolution processing” that is a patent invention invented by inventors of the present invention (see Patent Document 2) and “a fast method of super-resolution processing” that is disclosed in Patent Document 3 proposed by inventors of the present invention.

It is clear by comparing FIG. 3 with FIG. 4 that in order to generate an image capable of displaying all regions of interest that image quality is improved (i.e. all high-resolution-ized regions of interest) and the entire basis image, in the image processing based on the conventional “super-resolution processing”, with respect to multiple regions of interest that “the registration processing” is performed, it is necessary to perform “the high-resolution-ization processing” respectively for every region of interest and then perform “the embedding synthesis processing”.

On the other hand, in the image processing based on the present invention, although it is necessary to separately perform “the registration processing” for every region of interest, the next processing is only “the simultaneous image quality improvement processing”, that is to say, later, only the image quality improvement processing is simultaneously performed for all regions of interest that the registration processing is already performed and region(s) other than regions of interest.

Therefore, in the image processing based on the present invention, it is not necessary to perform “the embedding synthesis processing” which becomes necessary for the image processing based on the conventional “super-resolution processing” at all, and further, boundaries with unnatural edges existing in the result image (the embedded image) of the image processing based on the conventional “super-resolution processing”, do not exist in the result image of the image processing based on the present invention.

Hereinafter, we describe a concrete embodiment of the present invention in detail. In addition, in this embodiment, the high-resolution-ization processing is used as the image quality improvement processing.

By using a digital camera having a Bayer color filter, 30 images are captured. And the captured all images are full-colorized. The captured all images (30 images) that are full-colorized, are set as “multiple observed images” used in the image processing based on the present invention.

The initial frame (the first observed image) of these multiple observed images is set as the basis image. Along a flow shown in FIG. 4, the image processing based on the present invention is performed and an image-quality-improved image (an image-quality-improved image based on the present invention) is generated. In addition, FIG. 5 shows that basis image.

Region of interest 1, region of interest 2 and region of interest 3 that are indicated by squares of FIG. 5 and have the size of 40 [pixel]×40 [pixel], are manually appointed respectively by a user.

With respect to appointed region of interest 1, region of interest 2 and region of interest 3, “the registration processing” is performed respectively. In addition, in this embodiment, the method of Non-Patent Document 1 is used in “the registration processing”.

In “the simultaneous image quality improvement processing” of the present invention, by minimizing an evaluation function I represented by the following Expression 1 by simultaneously using the pixel value data of all regions of interest that the registration processing is already performed and the pixel value data of the basis image, the high-resolution-ization processing is performed, and an image-quality-improved image is generated. That is to say, “the simultaneous image quality improvement processing” sets a high-resolution image h minimizing the evaluation function I represented by Expression 1 as “the image-quality-improved image” that is the result image of the image processing based on the present invention.

$$I = {\sum }_{i = 1}^{{N}_{r}} {[ {g}_{r} ( {x}_{i} , {y}_{i} ) - B ( {x}_{i} , {y}_{i} ) h ]}^{2} + {\sum }_{j = 1}^{{N}_{j}} {\sum }_{k = 1}^{{N}_{k}} {\sum }_{( x , y ) ∈ {R}_{jk}} {[ {g}_{r} ( x , y ) - B ( {W}_{jk} ( x , y ) ) h ]}^{2} + C ( h ) \qquad [ Expression 1 ]$$

Where g, represents the basis image, gₖ represents the k-th observed image, (xᵢ,yᵢ) represents the pixel position of the i-th pixel of the basis image gᵣ, Nᵣ represents the number of total pixels of the basis image gᵣ, Nⱼ represents the number of regions of interest that are set in the basis image, Nₖ represents the number of observed images, and h represents the vector representation of the image-quality-improved image. Further, B(x,y) represents a matrix to estimate the pixel values (the pixel value data) of the basis image gᵣ in the pixel position (x,y) from the image-quality-improved image h. In addition, in this embodiment, Nₖ is 30 and Nⱼ is 3.

And then, Rⱼₖ represents pixels of a region in the k-th observed image that corresponds to the j-th region of interest, and Wⱼₖ represents a function that converts coordinates of the j-th region of interest in the k-th observed image into coordinates of the basis image gᵣ. Further C(h) represents a constraint term concerning the image-quality-improved image h.

In this embodiment, with respect to a method minimizing the evaluation function I represented by the above Expression 1 and the constraint term, the same methods as “a fast method of super-resolution processing” that is a patent invention invented by inventors of the present invention (see Patent Document 2) and “a fast method of super-resolution processing” that is disclosed in Patent Document 3, are used.

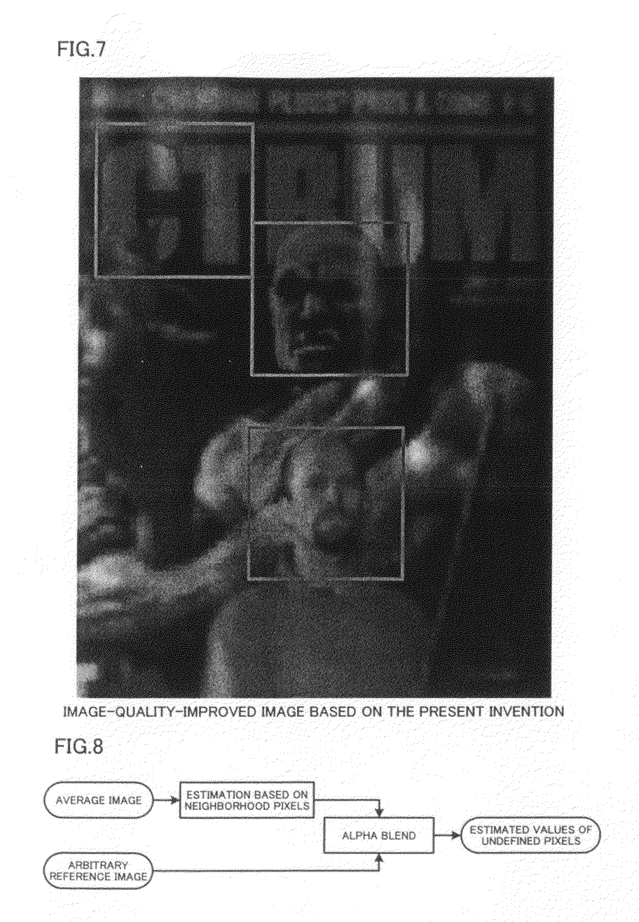

Furthermore, in this embodiment, the magnification of resolution of the image-quality-improved image for the observed image (the low-resolution image) is 3×3. FIG. 7 shows the image-quality-improved image obtained in this way (the image-quality-improved image based on the present invention).

It is clear from FIG. 7 that by applying the present invention, it was confirmed that the image-quality-improved image capable of displaying all high-resolution-ized regions of interest in the entire basis image is generated by one computation to “optimize the evaluation function I represented by the above Expression 1”.

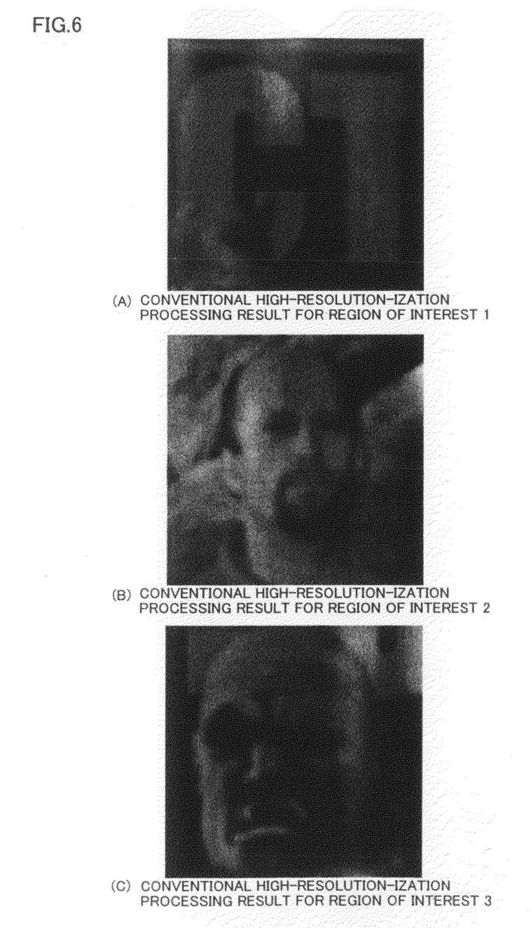

Here we describe the difference between the image processing based on the present invention and the image processing based on the conventional “super-resolution processing”. In the image processing based on the conventional “super-resolution processing”, in the case that multiple regions of interest exist, it is necessary to separately perform “the high-resolution-ization processing” for every region of interest, for example, after performing “the registration processing” respectively for three regions of interest shown in FIG. 5, “the high-resolution-ization processing” is performed respectively for each region of interest that the registration processing is already performed, and then with respect to each region of interest, high-resolution-ized images shown in FIG. 6 are obtained.

However, in order to display the entire basis image at the same time, it is necessary to perform an embedding synthesis processing that embeds high-resolution-ization processing results of three regions of interest shown in FIG. 6 (A), FIG. 6 (B) and FIG. 6 (C) in the basis image shown in FIG. 5). When simply performing such an embedding synthesis processing, a problem that boundaries of embedding become unnatural occurs.

On the other hand, in the image processing based on the present invention, since the image quality improvement processing (in this embodiment, the high-resolution-ization processing) is simultaneously performed for the basis image and three regions of interest, as shown in FIG. 7, the image-quality-improved image corresponding to the entire basis image is obtained. From FIG. 7, it is possible to confirm that in the image-quality-improved image obtained by the image processing based on the present invention, resolutions are improved with respect to three regions of interest and unnatural boundaries do not exist.

The above described an embodiment (hereinafter simply referred to as “Embodiment 1”) that “the simultaneous image quality improvement processing” sets the high-resolution image h that minimizes the evaluation function I represented by Expression 1 as “the image-quality-improved image” that is the result image of the image processing based on the present invention. We describe another embodiment of the present invention (Embodiment 2) as follows.

In Embodiment 2 of the present invention, “the simultaneous image quality improvement processing” is a processing that comprises a first step for generating an average image having undefined pixels and a weighted image by simultaneously using the pixel value data of multiple regions of interest that the registration processing is performed and the pixel value data of the basis image and a second step for generating an image-quality-improved image by estimating pixel values of the undefined pixels included in the average image.

We describe the details as follows.

Here, the pixel value data of multiple regions of interest that the registration processing is performed and the pixel value data of the basis image, are set as the ununiformly-sampled pixel value data (the pixel value data sampled at unequal interval) within “an image-quality-improved image space”.

These pixel positions sampled at unequal interval in “the image-quality-improved image space” (hereinafter also simply referred to as “the observed pixel positions”) are approximated by the pixel positions of the image-quality-improved image (hereinafter also simply referred to as “the image-quality-improved image pixel positions”). In this case, it can be considered that there are multiple observed pixels (i.e. multiple observed pixel positions) approximated by a certain image-quality-improved image pixel position. On the other hand, the image-quality-improved image pixel positions by which no observed pixel (i.e. the observed pixel position) is approximated, also exist.

Here, it is possible to generate an image by computing the average pixel value of multiple observed pixels approximated by each image-quality-improved image pixel position. In this embodiment, this image is called “an average registration image”. In addition, hereinafter this average registration image is also simply referred to as “an average image”.

The average registration image is equal to the image-quality-improved image in the pixel interval (the number of pixels). However, in the average registration image, the pixel value of the pixel position by which no observed pixel is approximated, is not defined. Here, a pixel within the average registration image that the pixel value is not defined, is referred to as “an undefined pixel”. In other words, since the undefined pixels are included in the average image, one can say is that the average image is not a complete image-quality-improved image. Further, with respect to all remaining pixels except the undefined pixels within the average image, since those pixel values are defined, hereinafter also simply referred to as “defined pixels”.

Further, the number of the observed pixels approximated by each image-quality-improved image pixel position also constructs an image. In the present invention, this image is called “a weighted image”.

In other words, the weighted image is equal to the average image in the number of pixels. Further, in the weighted image, the pixel values of pixels existing in positions that are the same as the pixel positions of the undefined pixels of the average image are zero, and pixels existing in positions that are the same as the pixel positions of the defined pixels of the average image have pixel values larger than zero. In other words, if the pixel value of the weighted image is zero, the pixel value will not be defined in corresponding average image. That is to say, both a pixel of the weighted image that the pixel value is zero and a pixel of corresponding average image are undefined pixels.

As described above, it is possible to generate the average image having the undefined pixels and the weighted image by simultaneously using the pixel value data of multiple regions of interest that the registration processing is performed and the pixel value data of the basis image. The resolution of the average image is the same as the resolution of the generated image-quality-improved image.

The point aimed at of this embodiment is that it is possible to generate (reconstruct) the image-quality-improved image by estimating the pixel values of the undefined pixels included in the average image. That is to say, it is possible to generate the image-quality-improved image if the pixel values of the undefined pixels of the average image can be estimated by some kind of methods.

As an estimation method of the pixel value of the undefined pixel, there are an interpolation method based on the pixel values of the defined pixels existing in the neighborhood of the undefined pixel (hereinafter also simply referred to as “the neighborhood pixels”), a replacement method that the pixel value of the undefined pixel is replaced with the pixel value of an arbitrary reference pixel and a method that performs the alpha blend of results obtained by the above interpolation method and the above replacement method.

Specifically, in this embodiment, at first, the average image and the weighted image are generated by simultaneously using the pixel value data of multiple regions of interest that the registration processing is performed and the pixel value data of the basis image, and then the image-quality-improved image is generated by estimating the pixel values of the undefined pixels included in the generated average image.

Next, we explain the estimation method of the pixel value of the undefined pixel included in the average image (hereinafter also simply referred to as “the undefined pixel value estimation method”) in detail.

### <1> The Undefined Pixel Value Estimation Method 1

“The undefined pixel value estimation method 1” is a method that estimates the pixel value of the undefined pixel by interpolating the pixel values of the defined pixels existing in the neighborhood of the undefined pixel (the pixel values of the neighborhood pixels).

As illustrative embodiments of the undefined pixel value estimation method 1, for example, it is possible to estimate the pixel value of an undefined pixel by

(a1) a method that interpolates the Red channel, the Green channel and the Blue channel independently,
(a2) a method that interpolates color difference channels (the Red-Green channel and the Blue-Green channel) after interpolating the undefined pixels of the Green channel, or
(a3) a method that firstly obtains the luminance (Y) after interpolating the pixel values of the Red channel, the Green channel and the Blue channel of the undefined pixels and then interpolates the undefined pixels again with respect to R-Y, G-Y and B-Y.

### <2> The Undefined Pixel Value Estimation Method 2

“The undefined pixel value estimation method 2” is a method that firstly prepares an arbitrary reference image having the number of the pixels same as the average image and then sets the pixel value of the reference image corresponding to the pixel position of an undefined pixel as the pixel value of the undefined pixel.

As illustrative embodiments of the undefined pixel value estimation method 2, for example, it is possible to set

(b1) an image obtained by magnifying an observed image,
(b2) an image obtained by firstly magnifying all observed images that are input and then averaging the magnified images after considering the displacements of these images, or
(b3) a single color image
as the reference image.

### <3> The Undefined Pixel Value Estimation Method 3

“The undefined pixel value estimation method 3” is a method that estimates the pixel value of the undefined pixel by performing the alpha blend of an undefined pixel value estimated by “the undefined pixel value estimation method 1” (hereinafter simply referred to as a first pixel value of the undefined pixel) and an undefined pixel value estimated by “the undefined pixel value estimation method 2” (hereinafter simply referred to as a second pixel value of the undefined pixel).

As illustrative embodiments of the undefined pixel value estimation method 3, for example, it is possible to estimate the alpha value (α) that is necessary in the case of performing the alpha blend by the following methods.

(c1) a method that changes the alpha value (α) of the alpha blend based on the pixel position of the undefined pixel.
(c2) a method that estimates the alpha value (α) of the alpha blend based on the number of the defined pixels existing in the neighborhood of the undefined pixel, i.e. the number of the neighborhood pixels.

We describe the pixel value estimation method of the undefined pixel in the average image (the undefined pixel value estimation method) in detail as follows.

### (1) The Undefined Pixel Value Estimation Using the Neighborhood Pixels

Here, (x,y) is set as the coordinate of the image, and I(x,y) is set as the average image (the average registration image). In this case, the pixel value Î(x,y) of the undefined pixel corresponding to the position (x,y) is estimated by the following Expression 2.

$$\hat{I} ( x , y ) = \frac{\begin{matrix}{\sum }_{\vert u \vert \leq R} {\sum }_{\vert v \vert \leq R} U ( u - x , v - y ) \\ w ( u , v ) I ( u - x , v - y )\end{matrix}}{{\sum }_{\vert u \vert \leq R} {\sum }_{\vert v \vert \leq R} U ( u - x , v - y ) w ( u , v )} \qquad [ Expression 2 ]$$

Where in the case that the pixel of (x,y) is not defined, U(x,y)=0 holds. On the other hand, in the case that the pixel of (x,y) is defined, U(x,y)=1 holds.

Further, w(x,y) represents a weighting function and R is a parameter that represents a neighborhood region. As the weighting function, for example, it is possible to utilize a Gaussian function.

Therefore, the high-resolution image h_{I} (x,y) generated by “the undefined pixel value estimation method using the neighborhood pixels”, can be represented by the following Expression 3.

h_{I}(x,y)=U(x,y)I(x,y)+[1−U(x,y)]Î(x,y) [Expression 3]

### (2) The Undefined Pixel Value Estimation Using the Reference Image

Here, T(x,y) is set as an arbitrary reference image. As the reference image, for example, it is possible to utilize an image obtained by magnifying the basis image or a single color image.

“The undefined pixel value estimation method using the reference image” is a method that the undefined pixel is replaced with T(x,y).

Therefore, the image-quality-improved image h_{T}(x,y) generated by “the undefined pixel value estimation method using the reference image”, can be represented by the following Expression 4.

h_{T}(x,y)=U(x,y)I(x,y)+[1−U(x,y)]T(x,y) [Expression 4]

### (3) The Method Applying the Alpha Blend

As shown in FIG. 8, “the method applying the alpha blend” to say here, is a method that estimates the pixel value of the undefined pixel by performing the alpha blend of the above “the undefined pixel value estimation using the neighborhood pixels” and the above “the undefined pixel value estimation using the reference image”.

Therefore, the image-quality-improved image h_{α}(x,y) generated by “the method applying the alpha blend”, can be represented by the following Expression 5.

h_{α}(x,y)=αh_{I}(x,y)+[1−α]h_{T}(x,y) [Expression 5]

Where α is the alpha value of the alpha blend.

It is possible to estimate the pixel values of the undefined pixels in the average image by the above undefined pixel value estimation methods. By this way, all pixels of the average will be defined. In this embodiment, the image-quality-improved image is generated by setting the average image that all pixels are defined as the image-quality-improved image.

In addition, it goes without saying that by using a computer system, it is possible to implement the image processing method (the image processing algorithm) according to embodiments of the present invention as described above by software.

### INDUSTRIAL APPLICABILITY

The most remarkable technical characteristic of the present invention is simultaneously performing the image quality improvement processing for multiple regions of interest set in the basis image and the basis image part except for these regions of interest (i.e. region(s) other than regions of interest), that is to say, is “the simultaneous image quality improvement processing”.

When applying the present invention, although it is necessary to perform the registration processing separately with respect to each region of interest, since simultaneously performing the image quality improvement processing for each region that is set as the region of interest and the registration processing is performed (i.e. each region of interest that the registration processing is already performed) and region (s) that the registration processing is not performed (i.e. region(s) other than regions of interest), as a result, an image that simultaneously displays each region of interest that image quality is improved and the entire basis image, is obtained.

That is to say, the result image generated by the present invention, is an image having a feature that each region of interest that the registration processing is performed is image-quality-improved, although the image quality does not change in region(s) that the registration processing is not performed (region(s) other than regions of interest), unnatural edges do not exist in boundaries between “region (s) other than regions of interest” where the image quality does not change and each image-quality-improved region of interest in the entire result image.

In other words, the result image based on the present invention is an image having the state that each image-quality-improved region of interest is naturally embedded into region(s) where the image quality does not change. In the result image of the present invention, boundaries having unnatural edges that occur in the case of performing the embedding synthesis that simply embeds each image-quality-improved region of interest in the basis image, do not occur.

In short, according to the present invention, a superior effect that in the case that multiple regions of interest exist in the basis image, after the registration processing is performed for each region of interest, by also using the basis image (when saying more closely, region(s) other than regions of interest), it is possible to simultaneously perform the image quality improvement processing without distinguishing each region of interest, is achieved.

For example, in the case of high-resolution-izing a scene (an image) including multiple faces such as a group photo, when using the conventional super-resolution processing method, it is necessary to separately perform “the registration processing” and “high-resolution-ization processing” for each face. Furthermore, since each face is separately high-resolution-ized, in order to simultaneously display the high-resolution-ized faces and the group photo that becomes the basis image, it is also necessary to perform the synthesis processing based on the embedding processing, and further, in an image obtained by such a synthesis processing, boundaries having unnatural edges also exist.

On the other hand, if using “the image quality improvement processing method and the image quality improvement processing computer program that correspond to multiple regions” according to the present invention (in addition, here the high-resolution-ization processing is used as the image quality improvement processing), although “the registration processing” is separately performed for every face, since simultaneously performing the high-resolution-ization processing for all faces that the registration processing is already performed and region(s) other than faces, boundaries having the conventional unnatural edges do not occur in the result image.

Further, since the result image generated by the present invention simultaneously displays the high-resolution-ized faces and the group photo that becomes the basis image, according to the present invention, a superior effect that it is unnecessary to perform “the embedding synthesis processing” that is necessary for the conventional super-resolution processing method to simultaneously display the high-resolution-ized faces and the group photo that becomes the basis image, and further it is possible to omit the necessary time of that processing, is achieved.

### THE LIST OF REFERENCES

Patent Document 1:
Japanese Patent Publication No. 2005-339422
Patent Document 2:
Japanese Patent No. 3837575
Patent Document 3:
Japanese Patent Publication No. 2006-309649
Non-Patent Document 1:
S Baker and I Matthews, “Lucas-Kanade 20 Years On: A Unifying Framework”, International Journal of Computer Vision, Vol. 5, No. 3, p. 221-255, 2004.

What is claimed is:

1. An image quality improvement processing method corresponding to multiple regions that generates an image-quality-improved image from multiple observed images having displacements, said method characterized by comprising:
a region of interest extraction processing step that extracts multiple regions of interest with respect to a basis image selected from said multiple observed images;
a registration processing step that performs the registration processing for every region of interest with respect to extracted multiple regions of interest; and
a simultaneous image quality improvement processing step that performs the image quality improvement processing by simultaneously using the pixel value data of multiple regions of interest that the registration processing is performed and the pixel value data of said basis image and generates said image-quality-improved image.

2. The image quality improvement processing method corresponding to multiple regions according to claim 1, wherein
as a method that extracts said multiple regions of interest, said region of interest extraction processing step uses
[1] a method that sets multiple regions appointed by a user with respect to said basis image as said multiple regions of interest,
[2] a method that sets multiple regions obtained by dividing said basis image into a predetermined size as said multiple regions of interest,
[3] a method that sequentially extracts the superiority region with respect to said basis image and sets extracted multiple superiority regions as said multiple regions of interest, or
[4] a method that extracts said multiple regions of interest by using object detection with respect to said basis image.

3. The image quality improvement processing method corresponding to multiple regions according to claim 1, wherein
said image quality improvement processing is an image quality improvement processing that performs the image quality improvement by minimizing an evaluation function represented by the following Expression,
$$I = {\sum }_{i = 1}^{{N}_{r}} {[ \begin{matrix}{g}_{r} ( {x}_{i} , {y}_{i} ) - \\ B ( {x}_{i} , {y}_{i} ) h\end{matrix} ]}^{2} + {\sum }_{j = 1}^{{N}_{j}} {\sum }_{k = 1}^{{N}_{k}} {\sum }_{( x , y ) ∈ {R}_{jk}} {[ \begin{matrix}{g}_{r} ( x , y ) - \\ B ( {W}_{jk} ( x , y ) ) h\end{matrix} ]}^{2} + C ( h )$$
where I represents said evaluation function, gᵣ represents said basis image, gₖ represents the k-th observed image, (xᵢ,yᵢ) represents the pixel position of the i-th pixel of said basis image gᵣ, Nᵣ represents the number of total pixels of said basis image gᵣ, Nⱼ represents the number of regions of interest that are set in said basis image, Nₖ represents the number of observed images, h represents the vector representation of said image-quality-improved image, B(x,y) represents a matrix to estimate the pixel value data of said basis image gᵣ in the pixel position (x,y) from said image-quality-improved image h, Rⱼₖ represents pixels of a region in the k-th observed image that corresponds to the j-th region of interest, Wⱼₖ represents a function that converts coordinates of the j-th region of interest in the k-th observed image into coordinates of said basis image gᵣ, and C(h) represents a constraint term concerning said image-quality-improved image h.

4. The image quality improvement processing method corresponding to multiple regions according to claim 1, wherein
said image quality improvement processing is a processing that comprises
a first step for generating an average image having undefined pixels and a weighted image by simultaneously using the pixel value data of multiple regions of interest that the registration processing is performed and the pixel value data of said basis image and
a second step for generating said image-quality-improved image by estimating pixel values of the undefined pixels included in said average image.

5. The image quality improvement processing method corresponding to multiple regions according to claim 4, wherein
said second step estimates the pixel value of said undefined pixel by interpolating pixel values of defined pixels existing in the neighborhood of said undefined pixel.

6. The image quality improvement processing method corresponding to multiple regions according to claim 4, wherein
said second step sets a predetermined image having the number of pixels same as said average image as a reference image and then sets the pixel value of a pixel of said reference image corresponding to said undefined pixel as the pixel value of said undefined pixel.

7. The image quality improvement processing method corresponding to multiple regions according to claim 4, wherein
a method that estimates the pixel value of said undefined pixel by interpolating pixel values of defined pixels existing in the neighborhood of said undefined pixel, is referred to as a first undefined pixel estimation method,
a method that sets a predetermined image having the number of pixels same as said average image as a reference image and then sets the pixel value of a pixel of said reference image corresponding to said undefined pixel as the pixel value of said undefined pixel, is referred to as a second undefined pixel estimation method,
said second step estimates the pixel value of said undefined pixel by performing the alpha blend of a first undefined pixel value estimated by said first undefined pixel estimation method and a second undefined pixel value estimated by said second undefined pixel estimation method.

8. The image quality improvement processing method corresponding to multiple regions according to claim 7, wherein
the alpha value of said alpha blend is changed based on the pixel position of said undefined pixel.

9. The image quality improvement processing method corresponding to multiple regions according to claim 7, wherein
the alpha value of said alpha blend is estimated based on the number of said defined pixels existing in the neighborhood of said undefined pixel.

10. An image quality improvement processing computer program corresponding to multiple regions that is embodied in a computer-readable medium and generates an image-quality-improved image from multiple observed images having displacements, said computer program is executable with a computer, comprising:
a step A1 that extracts multiple regions of interest with respect to a basis image selected from said multiple observed images;
a step A2 that performs the registration processing for every region of interest with respect to multiple regions of interest extracted in said step A1; and
a step A3 that performs the image quality improvement processing by simultaneously using the pixel value data of multiple regions of interest that the registration processing is performed in said step A2 and the pixel value data of said basis image and generates said image-quality-improved image.

11. The image quality improvement processing computer program corresponding to multiple regions according to claim 10, wherein
as a method that extracts said multiple regions of interest, said step A1 uses
[1] a method that sets multiple regions appointed by a user with respect to said basis image as said multiple regions of interest,
[2] a method that sets multiple regions obtained by dividing said basis image into a predetermined size as said multiple regions of interest,
[3] a method that sequentially extracts the superiority region with respect to said basis image and sets extracted multiple superiority regions as said multiple regions of interest, or
[4] a method that extracts said multiple regions of interest by using object detection with respect to said basis image.

12. The image quality improvement processing computer program corresponding to multiple regions according to claim 10, wherein
said image quality improvement processing is an image quality improvement processing that performs the image quality improvement by minimizing an evaluation function represented by the following Expression,
$$I = {\sum }_{i = 1}^{{N}_{r}} {[ \begin{matrix}{g}_{r} ( {x}_{i} , {y}_{i} ) - \\ B ( {x}_{i} , {y}_{i} ) h\end{matrix} ]}^{2} + {\sum }_{j = 1}^{{N}_{j}} {\sum }_{k = 1}^{{N}_{k}} {\sum }_{( x , y ) ∈ {R}_{jk}} {[ \begin{matrix}{g}_{r} ( x , y ) - \\ B ( {W}_{jk} ( x , y ) ) h\end{matrix} ]}^{2} + C ( h )$$
where I represents said evaluation function, gᵣ represents said basis image, gₖ represents the k-th observed image, (xᵢ,yᵢ) represents the pixel position of the i-th pixel of said basis image gᵣ, Nᵣ represents the number of total pixels of said basis image gᵣ, Nⱼ represents the number of regions of interest that are set in said basis image, Nₖ represents the number of observed images, h represents the vector representation of said image-quality-improved image, B(x,y) represents a matrix to estimate the pixel value data of said basis image gᵣ in the pixel position (x,y) from said image-quality-improved image h, Rⱼₖ represents pixels of a region in the k-th observed image that corresponds to the j-th region of interest, Wⱼₖ represents a function that converts coordinates of the j-th region of interest in the k-th observed image into coordinates of said basis image gᵣ, and C(h) represents a constraint term concerning said image-quality-improved image h.

13. The image quality improvement processing computer program corresponding to multiple regions according to claim 10, wherein
said image quality improvement processing is a processing that comprises
a first step for generating an average image having undefined pixels and a weighted image by simultaneously using the pixel value data of multiple regions of interest that the registration processing is performed and the pixel value data of said basis image and
a second step for generating said image-quality-improved image by estimating pixel values of the undefined pixels included in said average image.

14. The image quality improvement processing computer program corresponding to multiple regions according to claim 13, wherein
said second step estimates the pixel value of said undefined pixel by interpolating pixel values of defined pixels existing in the neighborhood of said undefined pixel.

15. The image quality improvement processing computer program corresponding to multiple regions according to claim 13, wherein
said second step sets a predetermined image having the number of pixels same as said average image as a reference image and then sets the pixel value of a pixel of said reference image corresponding to said undefined pixel as the pixel value of said undefined pixel.

16. The image quality improvement processing computer program corresponding to multiple regions according to claim 13, wherein
a method that estimates the pixel value of said undefined pixel by interpolating pixel values of defined pixels existing in the neighborhood of said undefined pixel, is referred to as a first undefined pixel estimation method,
a method that sets a predetermined image having the number of pixels same as said average image as a reference image and then sets the pixel value of a pixel of said reference image corresponding to said undefined pixel as the pixel value of said undefined pixel, is referred to as a second undefined pixel estimation method,
said second step estimates the pixel value of said undefined pixel by performing the alpha blend of a first undefined pixel value estimated by said first undefined pixel estimation method and a second undefined pixel value estimated by said second undefined pixel estimation method.

17. The image quality improvement processing computer program corresponding to multiple regions according to claim 16, wherein
the alpha value of said alpha blend is changed based on the pixel position of said undefined pixel.

18. The image quality improvement processing computer program corresponding to multiple regions according to claim 16, wherein
the alpha value of said alpha blend is estimated based on the number of said defined pixels existing in the neighborhood of said undefined pixel.
